(19) United States
(12) Patent Application Publication
(10) Pub. No.: US 2023/0341072 A1
(43) Pub. Date: Oct. 26, 2023

(54) DEVICE TO PROTECT WATER PIPE FROM WATER HAMMERING AND FROZEN WATER EXPANSION

(71) Applicant: Stephan SODER, Grüningen (CH)

(72) Inventor: Stephan SODER, Grüningen (CH)

(21) Appl. No.: 17/920,003

(22) PCT Filed: Apr. 27, 2020
(86) PCT No.: PCT/IB2020/053923

§ 371 Date: Oct. 19, 2022

Related U.S. Application Data
(63) Continuation of application No. 16/854,946, filed on Apr. 22, 2020, now abandoned.

(51) Int. Cl. F16L 55/053; E03B 7/10

(52) U.S. Cl. CPC F16L 55/053; E03B 7/10

(57) ABSTRACT

A device designed to relieve expanded volume, flow and pressure within a water pipe system by utilizing a pair of spring loaded pistons within a valve body, such that the increases volume caused by various sources can be accommodated within the valve body by the spring loaded pistons. The device allows normal flowing under regular operating parameters and will perform its function automatically as the flow and pressure increases beyond the spring setting. The device will reset to its starting configuration after the operating parameters return to normal without external monitoring or input.

### CROSS-REFERENCE TO RELATED APPLICATION

The present application relates and claims priority to U.S. utility non-provisional patent application Ser. No. 16,854,946 filed on 22 Apr. 2020.

### FIELD OF THE INVENTION

This invention relates to water system in residential and business buildings, including other applications utilizing pipe systems including weekend homes, camper, caravan, offshore facilities, factories, boats, vessels and others. During cold climates, water in the pipes has been known to expand as a result of freezing, which can cause significant damage in the system. The present invention can be integrated onto existing system with ease. Once installed, it ensures normal operation, and will relieve the expanded water volume in cold climates. The device also provides pressure reducing function in conditions that introduce increased pressure within the pipe system through spring loaded pistons.

### BACKGROUND OF THE INVENTION

In recent years many parts of the world have been experiencing colder and more prolonged severe weather conditions over the winter months. Water pipe systems, both in residential and business settings, are known to be affected by frozen water during this time. When water in the pipe is exposed to below freezing temperature, they turn into ice and expands beyond the normal volume. With no outlet, this kind of expansion would push against the water pipe to the point of breakage. Subsequently, once the temperature rises above freezing point, the ice return to its liquid state and would leak through the broken section of the pipe. Frequently, this condition results in significant damage in both the water pipes themselves, as well as surrounding structures due to the water leak.

Conventionally, insulation material can be wrapped around sections of the pipe that are susceptible to freezing conditions. This potentially delays or prevents the water in that section of the pipe from freezing, and protects the pipe system locally. However, this method cannot fully prevent freezing, and is only effective in the sections that are covered. Other sections of the pipe may still experience freezing temperatures, and the entire system is once again compromised by the unprotected section of the pipes. Often, a small ice plug that forms in a pipe bend and interrupts the water cycle. Subsequently, the whole pipe freezes over. Further, when uncovered sections of the pipe system experience freezing conditions, the expanded volume resulted from freezing water may cause increased pressure in sections of the pipe away from the frozen sites. Due to the enclosed condition of many pipe system, the transferred volume change may produce force strong enough to break through the weakest sections of the pipe. Regardless of whether there is external protection, the entire system is still at risk.

When a new pipe system is designed, consideration is usually taken to minimize such damage. The issue compounds when older existing water pipe system requires protection, and would result in dramatic modification of the entire system. This is because few standalone products can be retrofitted onto older systems without significantly modifying the pipe placement and configuration. Owners of aging pipe systems are particularly susceptible as they are less likely to be adapted into new design plans. This results in significant financial and manpower strain for owners to prepare for each cold season.

There is a need for a device that is capable of relieving water pressure resulting from frozen pipes, that also provides ease of use and access during installation. The goal is to have device that would require minimal modification on the existing system, while providing effective remedy to this known issue. Further, the device needs to be scalable to accommodate various size and scope of pipe systems.

### SUMMARY OF THE INVENTION

The present invention is designed to be effectively installed onto existing systems and provide immediate relief to pipes that are susceptible to frozen water conditions. The compact structure of the device ensures only a small section of the pipe need to be removed during installation, and can be scaled depending on the size of the pipe or and the expected volume change during freezing conditions. Once installed, it does not impact the flow rate and operation of the pipe system during normal conditions, as it performs its function seamlessly as required. There is no monitoring required, as the device functions as needed without manual prompt. Further, it is designed to be automatically reset when the condition improves. It features competitive advantage by being a fully automated device without reliance on power input, and will function bi-directionally without any user input through the process.

In the preferred embodiment, the present device is constructed with two sections for ease of installation. First, a section of the pipe is removed. Secondly, each section of the device is installed onto one end of the pipe, respectively. Next, the two sections are attached together, to provide seamless connection within the pipe. Once installed, the present device occupies the section of the pipe and provides unobstructed flow during normal operation.

Each section of the present device contains a spring-loaded piston mechanism that allows free movement within the device when pressure builds up and volume expands. During normal operation, water is allowed to fill a space between the two piston mechanism. This does not trigger any further movement of components in the device unless the operating condition requires. Each spring is set to accommodate standard operating pressure within the pipe, to ensure unhindered flow under normal conditions.

In the preferred embodiment, each spring-loaded piston will be pushed back if the water within the space between is subject to increased pressure and forced to expand. As water in sections of the pipe freezes, the same volume of water would be converted into larger volume of ice. Should this transformation occur at the site of the present device, each spring-loaded piston will be pushed back by the resulting ice. Should this transformation occur at other sections of the pipe system, the change in system volume could push the spring loaded pistons back through transfer of volume in accordance to fluid dynamic principles. The present device would thus provide appropriate volume and pressure relief.

Once the freezing condition eases, the system volume returns to normal as ice melts, and the spring loaded pistons will shift back into their original configuration. As such, the present device does not require any external monitoring or resetting. The operating condition will dictate whether the function of the device is required, and automatically initiate and terminate its function as needed. This further provides ease of use for home and business owners, as it provides a peace of mind on its own once installed.

Another embodiment of this device is to be used to counter the harmful effect of water hammering. Water hammering occurs when a surge of volume and pressure is introduced to the pipe system, due to the sudden closure of outlets. The incoming water flow is not stopped immediately, and creates increased pressure inside the now closed pipe system. The surge cannot find relief within the pipe system. As result, it can cause sudden and dramatic damage within the pipes. By utilizing the basic principle in volume transfer, the present device provides effective means to expand the internal volume of the pipe system to counter water hammering. In the same manner that it counters freezing conditions, the device allows measurable amount of volume expansion and in turn pressure relief by contracting the spring loaded pistons. Because there is no manual trigger or monitoring required, the pistons will move automatically and immediately when the pressure and volume of the water in the pipe increases suddenly. This provides immediate relief when water hammering condition takes place. Once again, when the effect subsites, the pistons move back to their original configuration without external prompt. When functioning properly, the present device protects the pipe system without raising any alarms, and the business and homeowners will not notice any negative effects occurring.

The present device can be created with various size and configuration of pistons and springs, to further accommodate individual needs of each application, not necessarily as specified by the proportion demonstrated in the drawing and figures.

### BRIEF DESCRIPTION OF THE DRAWINGS

The invention is herein described, by way of example only, with referenced to the accompanying drawings, wherein:

FIG. 1 is a graphical illustration of and embodiment of the device

FIG. 2 is a graphical illustration of the construction of the device

FIG. 3 is an exploded view of the components of the system of the device

### DETAILED DESCRIPTION OF THE INVENTION

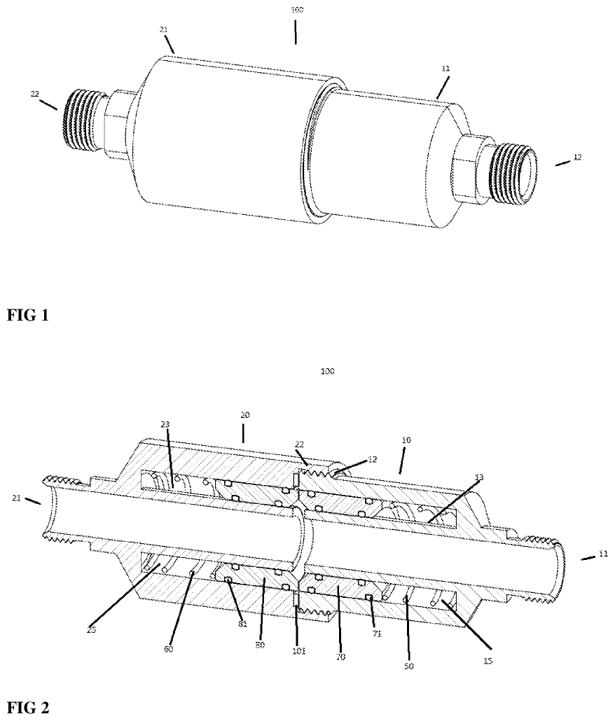

Illustrated in FIG. 1. is the preferred embodiment of a device used to relieve potential damage from freezing water in the pipe system. The valve body 100 is made of a male cannister 10 and a female cannister 20 for ease of fitment to existing systems. When joined together, the male cannister 10 and female cannister 20 form a valve body 100 that can be installed onto existing pipes. The female cannister 20 has an external means 21 to attach itself to an upstream or downstream pipe, and the male cannister 10 has another external means 11 to attach itself to the opposing pipe. In a preferred embodiment, a washer 101 is placed in a groove between male cannister 10 and female cannister 20 to facilitate better seal. The valve body 100 allows normal water flow in the pipe section that it replaces in non-freezing temperatures.

Illustrated in FIG. 2. is the construction of preferred embodiment of system of the invention. The male cannister 10 has a means 12 to allow itself to be attached to the female cannister 20 by its corresponding means 22. In this preferred embodiment, the male cannister 10 has threaded means 11 on the outside enclosure, and the female cannister 21 has threaded means 21 on the inside cavity. When aligned together these threads allow the unit to be assembled without utilizing external tools.

The male cannister 10 has a tubular core 13 that forms an annular and cylindrical cavity 14 inside the cannister 10. In the preferred embodiment, the tubular core 13 is constructed as one piece with the rest of the male cannister 10, originating from its enclosure end. The tubular core 13 forms a longitudinal pathway within its hollow cavity through the length of the male cannister 10, allowing fluid to pass through its center during operation. The tubular core 13 and the inner surface of the cannister 10 form a cylindrical cavity. The female cannister 20 has a corresponding tubular core 14 of the same construction and structure, providing the same intended function.

The male cannister 10 has a spring 50 placed around the tubular core 13. The spring 50 is placed flush against the enclosure end of the male cannister 10. The spring 50 fits within the cylindrical cavity 15, and is allowed to extend and contract freely within the cavity. The female cannister 20 also has a spring 60 placed around its tubular core 14, flush against its enclosure end.

A piston 70 is placed around the tubular core 13, and a corresponding piston 80 is placed around the tubular core 23 of the other cannister. In the preferred embodiment, the piston 70 is flush radially between the tubular core 13 and the inner surface of the male cannister 10, such that the spring 13 is sandwiched between the piston 70 and the enclosure end of the male cannister 10. The flush placement of the piston 70 ensures the cylindrical cavity 15 is isolated from a fluid that may flow through the tubular core 13 and come in contact with the piston 70. In a preferred embodiment, the piston is constructed with annular grooves on its outer surface, so that elastic o-rings 71 can be placed around the piston. This allows an air-tight seal around the tubular core 13 to prevent fluid from entering the cylindrical cavity 15.

An annular piston 80 is placed around the tubular core 23 of the female cannister 20, in the same placement and structure as its corresponding piston 70. This creates another air tight cavity 25 in the female cannister. In a preferred embodiment, the annular piston 80 also has annular grooves around its outer surface to facilitate elastic o-rings 81.

In a preferred embodiment, the tubular core 13 and 14 are in contact of each other when the male cannister 10 and the female cannister 20 are jointly attached, creating a longitudinal pathway through the valve body 100.

As illustrated in FIG. 2, when the male cannister 10 and the female cannister 20 are jointly attached, the spring 50 extends under normal operating parameter to push the annular piston 70 into contact with piston 80, which is also pressed into position by the spring 60. In such a configuration, the piston 70 is flush against the piston 80, and a longitudinal pathway is formed by the two pistons and the two tubular cores. In a preferred embodiment, this allows fluid to pass through the valve body 100 from end 11 to end 21 unrestricted under normal operating parameters.

In a preferred embodiment each piston 70 80 is constructed with angular grooves on each end, creating a space between the two pistons and the tubular cores 13 23. Indentations are constructed on the tubular cores 13 and 23 to form at least one orifice when the cores are in contact with each other as illustrated in FIG. 2. This allows fluid to flow into and fill the space between the two pistons.

In this configuration, fluid is allowed to flow unrestricted through the longitudinal pathway while the operating pressure is within normal conditions. Fluid is also allowed to enter into the space between the two pistons through the orifices on the tubular cores 13 23 during normal operation.

In one embodiment, the tubular core 13 and 23 are of such length that they do not come in contact with each other. This configuration will provide access for water to enter into the space between the two pistons 70 80 instead of the orifice. The configuration of the tubular core, the pistons, and the valve body 100 ensure free water flow under normal operation parameters.

Due to the flush placement of the pistons between the tubular cores 13 23 and the inner cavity of the cannisters, fluid is not going to enter the space 15 passed the pistons. This ensures that fluid will not be in contact with the springs 50 and 60, and thus will not interfere with movements of the springs 60 and 60 and the pistons 70 and 80. In the preferred embodiment, o-rings constructed with elastic plastic material will be placed around grooves on the pistons, to allow better seal of the cavity 15 from fluid present in the longitudinal pathway.

Depending on the varying pressure in the flow within the pipe, the pistons 70 and 80 would move accordingly against the springs 50 and 60 to accommodate any volume expansion and pressure build up within the device. In the preferred embodiment, spring 70 and 80 are selected to withstand the standard pressure expected in the pipes, and only contract and allow the pistons 70 and 80 when the flow volume and pressure increases beyond the expected threshold. Such setting can be easily changed by replacing either spring 50 or 60 or both based on user's preference, and allows customization based on each application's need. Due to the construction of the present device, replacing these springs can be done easily in the field.

Multiple sources can cause an increase amount of fluid entering into the pipe, and in turn in the space between the pistons 70 and 80. There could be a surge of inlet flow; water could be frozen in other sections of the pipe to push water into the space occupied by the present invention; outlet on the pipe system could be blocked to create a back flow build up; and finally the volume of fluid inside the present device could increase when it freezes. Such increased amount of fluid is allowed to enter through the at least one orifice into the space between pistons 70 and 80. These pistons, supported by springs 50 and 60, will be pushed away from each other as the space between them expands. In one embodiment example, when the temperature drops to freezing point, the water in the space freezes and, as it expands, pushes against the spring loaded pistons 70 80, relieving the pressure of static frozen expansion. Due to seal structure created by the flush placement of the spring loaded pistons, movement of both the pistons and the springs will not be interfered by fluid entering the cavity space 15 25.

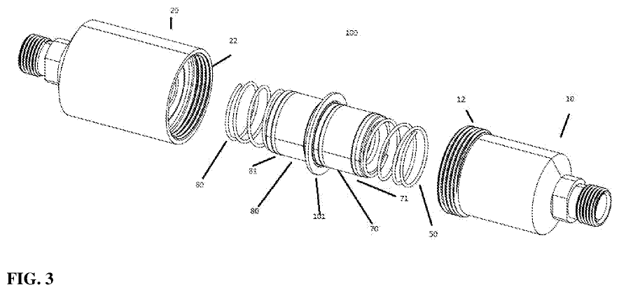

In a preferred embodiment, as illustrated in FIG. 3, a vent escape hole 14 is placed towards the enclosure end of the male cannister 10, so that air can escape through the escape hole in order to allow the piston to move under pressure. In situations where the increase of the volume is sudden and dramatic, the movement inside an enclosed space can create a pressurized space that can stop the pistons from engaging properly. As such, the vent escape hole 14 allows air to relieve, providing free movement to the mechanisms in the cavity 15 25.

As pressure and flow builds up inside the pipe, the pistons 50 and 60 will remain retreated and the springs 70 and 80 will remain contracted as long as the pressure against the pistons are greater than the rest spring settings. The volume the present device is allowed to with stand is in proportion to the cavity 15 25 as set by the springs 70 80. It is understood by a person with ordinary skills in the art that functions described herein for the present device can be created with various size and configuration of pistons and springs, to further accommodate individual needs of each application, not necessarily as specified by the proportion demonstrated in the drawing and figures.

As the surge flow and pressure decreases, the spring 70 and 80 will naturally extend as their tensile strength overcomes external force, and push pistons 50 and 60 towards one another. The positions of pistons 50 60 are dependent on the proportion of the increased pressure present in the valve body against the spring settings, and will remain as long as the pressure within the valve body remains steady. Once the flow and pressure return to normal operating conditions, the pistons 50 and 60 will return in contact with one another, allowing the longitudinal pathway through the valve body to be form at its starting configuration. There is no external monitoring device or control mechanism required to facilitate the functions within the valve body, and the flow in this section of the pipe will return to regular setting on its own. Thus, the valve body performs auto-reset functions as required by the flow present within the present device without external input.

Due to the construction of the present device, each piston 50 60 is able to move independently of one another. Thus, the device can function bi-directionally without dedicated inlet and outlet. The movement of the springs 70 80 and pistons 50 60 does not differentiate whether the flow is from one direction or another, as their function relies only on the pressure and volume build up in the space between each piston 50 60. Therefore, there is no concern that this device would be installed incorrectly to disrupt the normal operation in the pipe system. As long as the device is attached properly onto a pipe, it will begin functioning properly and immediately.

In the preferred embodiment, the valve body 100 is constructed with a combination of steel and brass material. It is understood that the present device can be constructed with a different combination of material based on the application demand.

What is claimed is:

1. A device designed to prevent pipe damage caused by expanding frozen water, comprising:
an valve body with a first and a second cannister, each with a closure end and an open end, that form a cylindrical cavity when joined laterally by each open end; each first and second cannister further having a tubular core extending longitudinally from the closure until before the open end, such that when each first and second cannister join laterally by each open end forms a longitudinal pathway throughout the valve body between each tubular core; each first and second cannister has means on its enclosure end to be attached to a receiving pipe section;
a connecting ring between each first and second cannister;
a first and second spring, each placed around the tubular core and at the enclosure end of each first and second cannister; and
a first and second piston, each placed around the tubular core abutting the spring in each first and second cannister; each piston is radially flush between the tubular core and the cylindrical cavity of the valve body, such that space occupied by each first and second spring is sealed from the longitudinal passage through the valve body; each first and second piston are pressed into contact with each other by the first and second spring;
each tubular core of first and second cannister has at least one orifice to lead to space between each piston.

2. A device according to claim 1, wherein each piston has at least one annular indentation with a rubber ring placed therein.

3. A device according to claim 1, wherein each piston further having angular indentation towards open end of each cannister.

4. A device according to claim 1, wherein each cannister has at least one vent escape hole through to the cavity space occupied by each first and second spring.

5. A device according to claim 1, wherein each tubular core has at least one orifice that lead to space between the pistons, granting access to the longitudinal pathway through the valve body.

6. A device according to claim 1, wherein each tubular core is of such length that they do not come in contact when the cannisters are connected.

7. A device according to claim 1, wherein each first and second cannister has means on its enclosure end to be attached to a receiving pipe section that are threading means;

8. A device according to claim 1, where in each first and second cannister attach its enclosure end to a pipe section with a locking nut;

9. A device designed to adapt increased flow and pressure within water pipes, comprising:
an valve body with a first and a second cannister, each with a closure end and an open end, that form a cylindrical cavity when joined laterally by each open end; each first and second cannister further having a tubular core extending longitudinally from the closure until before the open end, such that when each first and second cannister join laterally by each open end forms a longitudinal pathway throughout the valve body;
a connecting ring between each first and second cannister;
a first and second spring, each placed around the tubular core and at the enclosure end of each first and second cannister;
a first and second piston, each placed around the tubular core abutting the spring in each first and second cannister; each piston is radially flush between the tubular core and the cylindrical cavity of the valve body, such that space occupied by each first and second spring is sealed from the longitudinal passage through the valve body; each first and second piston are pressed into contact with each other by the first and second spring;

10. A device according to claim 9, wherein each piston has at least one annular indentation with a rubber ring placed therein.

11. A device according to claim 9, wherein each piston further having angular indentation towards open end of each cannister.

12. A device according to claim 9, wherein each cannister has at least one vent escape hole through to the cavity space occupied by each first and second spring.

13. A device according to claim 9, wherein each tubular core has at least one orifice that lead to space between the pistons, granting access to the longitudinal pathway through the valve body.

14. A device according to claim 9, wherein each tubular core is of such length that they do not come in contact when the cannisters are connected.

15. A device according to claim 9, wherein each first and second cannister has means on its enclosure end to be attached to a receiving pipe section that are threading means;

16. A device according to claim 9, where in each first and second cannister attach its enclosure end to a pipe section with a locking nut;
